(19) United States
(12) Patent Application Publication
(10) Pub. No.: US 2025/0363879 A1
(43) Pub. Date: Nov. 27, 2025

(54) LOCALIZATION AND MONITORING OF ENVIRONMENTAL CONDITIONS

(71) Applicant: Microchip Technology Incorporated, Chandler, AZ (US)

(72) Inventors: Patrick McFarland, Gilbert, AZ (US); Arthur B. Eck, Gilbert, AZ (US)

(73) Assignee: Microchip Technology Incorporated, Chandler, AZ (US)

(21) Appl. No.: 18/951,259

(22) Filed: Nov. 18, 2024

Related U.S. Application Data
(60) Provisional application No. 63/651,438, filed on May 24, 2024.

(51) Int. Cl. G08B 17/10; G06T 11/20

(52) U.S. Cl. CPC G08B 17/10; G06T 11/206

(57) ABSTRACT

A method includes receiving a first alert from a first environmental condition detection device indicating a presence of an environmental condition. Determining a location of the first environmental condition detection device. Determining a condition intensity value for the first environmental condition detection device based on the first alert. Generating a heatmap to depict the location and the condition intensity value for the first environmental condition detection device. Receiving a second alert from a second environmental condition detection device indicating a presence of the environmental condition. Determining a location of the second environmental condition detection device based on the second alert. Determining a condition intensity value for the second environmental condition detection device based on the second alert. Revising a heatmap to depict the location and the condition intensity value for the second environmental condition detection device.

### RELATED PATENT APPLICATION

This application claims priority to commonly owned U.S. Provisional Patent Application No. 63/651,438 filed May 24, 2024, the entire contents of which are hereby incorporated by reference for all purposes.

### TECHNICAL FIELD

The present disclosure relates to environmental condition detection devices such as smoke alarms and, more particularly, to localization and monitoring of environmental conditions using a network of environmental condition detection devices.

### BACKGROUND

Environmental condition detection devices, such as smoke detectors and carbon monoxide detectors, rely on various sensors to detect different types of hazards and environmental conditions. For example, some smoke detectors include a photoelectric detector, an ionization detector, or a combination of both. In an environmental condition detection device, an alarm may be triggered when smoke is detected based upon the amount of light detected from a light source onto a light sensor. In an ionization smoke detector, ionized air molecules attach to the smoke particles that enter the chamber, changing the ionizing current, which may result in an alarm being triggered based on the change in the ionizing current. Such smoke detectors may be used to detect fires in large commercial and industrial buildings, as components in a larger fire alarm system.

In general, the ionization detector reacts faster than the photoelectric detector in responding to flaming fires, and the photoelectric detector is more responsive to smoldering fires. Because an ion detector tests the air for small combustible particles, it can be fooled by chemical or paint particles in the atmosphere. The photoelectric detector, which needs to “see” the smoke from the fire, can be fooled by objects, dust, humidity, or even insects. Though both offer protection against undetected fires, ionization detectors experience a higher incidence of nuisance alarms.

Environmental condition detection devices may also be referred to as optical beam smoke detectors. Environmental condition detection devices include at least one light transmitter and one light sensor to receive the transmitted light. The photosensitive receiver is used to monitor light received from the transmitter, both under normal conditions and under environmental conditions. There are two primary types of environmental condition detection devices, the light-obscuration type and the optical-scattering type. The principle of light obscuration, where the presence of smoke blocks some of the light from the light source beam from reaching the light sensor. In the absence of smoke, light passes from the light transmitter to the receiver in a straight line. In a fire, when smoke falls within the path of the beam detector, some of the light is obscured (e.g., absorbed or scattered by the smoke particles). This creates a decrease in the received light signal from the light sensor, leading to an increase in optical obscuration, which is a reduction of transmittance of light across the beam path. Once a certain percentage of the transmitted light has been obscured by the smoke compared to a baseline signal, a fire alarm may be triggered. In the light-scattering type detector, the optical beam does not align with the photosensor so that under normal conditions no or very little light is received by the photosensor. When smoke particles enter the photo chamber, smoke is scattered or reflected onto the photosensor, and alarm may be triggered when the scattered light detected by the photosensor exceeds a threshold value when compared to a baseline signal.

Environmental condition detection devices, such as smoke detectors, are usually required by law to be in buildings, especially high occupancy ones, such as factories and apartment complexes. Due to the large physical size of these buildings, there are often many devices present at a given time. For example, hotels, apartment complexes, large venues, commercial complexes such as office buildings, and industrial complexes such as manufacturing facilities and warehouses, may include up to one hundred or more environmental condition detection devices. In some applications multiple environmental condition detection devices may be networked together, allowing them to communicate with each other and a central monitoring location. The networked devices often connect back to a central monitoring station, e.g., in a security location. The central monitoring location controls and monitors device activity and can alert one or more of building maintenance, occupants, and emergency services, without limitation, depending on the nature of the environmental condition detected.

In such systems it can be difficult to locate and monitor the source of environmental conditions. Environmental conditions may include gas leaks, water leaks, fires, unexpected temperatures, and concentrations of toxic gases, without limitation. When an environmental condition such as fire or toxic gas is detected by an environmental condition detection device in such a system, the environmental condition detection device may sound an alarm and may send an alert to the monitoring station. Environmental condition detection devices are currently unable to determine the location of an environmental condition and merely determine it is present. Many devices do not send data from the sensor in the environmental condition detection device, e.g., data corresponding to the amount of obscuration in a light-obscuration type smoke detector, data corresponding to the intensity of scattered light in an optical-scattering type smoke detector, or data corresponding to the amount of ionization in an ionization type smoke detector. Multiple sensors may alarm, but the exact location of the source may still be unclear and could take additional time and resources to find. Additionally, if the environmental condition is spreading, the direction and rate of spread may be unclear. In the case where an environmental condition presents a hazard to human health, locating the source as quickly as possible is of the upmost concern. Promptly informing users of the location of an environmental condition could save time, money, and even prevent injury or death.

There is a need to monitor an environmental condition and determine a source location of the environmental condition.

### SUMMARY

According to aspects, there is provided a method, comprising: receiving a first alert from a first environmental condition detection device based on the detection of an environmental condition characteristic in proximity to the first environmental condition detection device, wherein: the first environmental condition detection device comprises a sensor to detect a magnitude of the environmental condition characteristic; the first alert indicates a first magnitude of the environmental condition characteristic detected by the sensor; determining a location of the first environmental condition detection device; determining a first relative location of the environmental condition based on the location of the first environmental condition detection device; determining a first intensity value for the environmental condition based at least in part on the magnitude of the environmental condition characteristic indicated by the first alert; and generating a heatmap to graphically represent the first relative location and first intensity value of the environmental condition.

An aspect as in the preceding paragraph provides a method, wherein: the magnitude of the environmental condition characteristic is indicated by a value from the sensor, wherein the value corresponds to current or voltage; the first alert comprises a timestamp and identification information for the first environmental condition detection device; the location of the first environmental condition detection device is determined by referencing a database comprising identification and location information; the first relative location of the environmental condition is centered on the location of the first environmental condition detection device; and the first intensity value is graphically represented by a radius, a color, or a combination thereof.

An aspect as in one of the preceding two paragraphs provides a method, comprising: receiving a second alert from the first environmental condition detection device, wherein the second alert indicates a second magnitude of the environmental condition characteristic detected by the sensor; determining a second intensity value for the environmental condition based at least in part on the second magnitude of the environmental condition characteristic indicated by the second alert; and revising the heatmap to graphically represent the second intensity value for the environmental condition.

An aspect as in one of the preceding three paragraphs provides a method, comprising: receiving a second alert from a second environmental condition detection device based on the detection of an environmental condition characteristic in proximity to the second environmental condition detection device, wherein: the second environmental condition detection device comprises a sensor to detect a magnitude of the environmental condition characteristic; the second alert indicates a second magnitude of the environmental condition characteristic detected by the sensor; determining a location of the second environmental condition detection device based at least in part on the second alert; determining a second relative location of the environmental condition based at least in part on the location of the second environmental condition detection device; determining a second intensity value for the environmental condition based at least in part on the magnitude of the environmental condition characteristic indicated by the second alert; and revising the heatmap to graphically represent the second relative location and second intensity value of the environmental condition.

An aspect as in one of the preceding four paragraphs provides a method, wherein: determining the second relative location of the environmental condition comprises determining an intermediate location relative to the locations of the first and second environmental condition detection devices, the intermediate location to represent a more likely location of the environmental condition than the locations of the first and second environmental condition detection devices; and revising the heatmap to graphically represent the second relative location comprises graphically representing the intermediate location.

An aspect as in one of the preceding five paragraphs provides a method, comprising: determining a direction of spread for the environmental condition based at least in part on the relative locations of the first and second environmental condition detection devices; determining a rate of spread for the environmental condition based at least in part on a difference in time between receiving the first and second alerts; and revising the heatmap to graphically represent the direction and rate of spread for the environmental condition.

An aspect as in one of the preceding six paragraphs provides a method, wherein the heatmap visually depicts a location and an intensity of the environmental condition using color coding, gradients, topographical lines, or a combination thereof.

An aspect as in one of the preceding seven paragraphs provides a method, wherein the environmental condition characteristic comprises smoke particles, light, heat, odor, a toxic gas, or a combination thereof.

An aspect as in one of the preceding eight paragraphs provides a method, comprising: determining a safe exit path for people to avoid the environmental condition based on the heatmap; and revising the heatmap to indicate the safe exit path.

According to an aspect, there is provided a system, comprising: a plurality of environmental condition detection devices, each environmental condition detection device comprising a sensor to detect a magnitude of an environmental condition characteristic; a central computer connected to the plurality of environmental condition detection devices and the database, the central computer to: receive a first alert from a first environmental condition detection device based on the detection of the environmental condition characteristic in proximity to the first environmental condition detection device, wherein the first alert indicates a magnitude of the environmental condition characteristic detected by the sensor of the first environmental condition detection device; determine a location of the first environmental condition detection device; determine a first relative location of the environmental condition based on the location of the first environmental condition detection device; determine a first intensity value for the environmental condition based at least in part on the magnitude of the environmental condition characteristic indicated by the first alert; and generating a heatmap to graphically represent the first relative location and first intensity value of the environmental condition.

An aspect as in the preceding paragraph provides a system, comprising: a database connected to the central computer, the database comprising information regarding the identity and location of each environmental condition detection device of the plurality of environmental condition detection devices; wherein: the magnitude of the environmental condition characteristic is indicated by a value from the sensor, wherein the value corresponds to current or voltage; the first alert comprises a timestamp and identification information for the first environmental condition detection device; the location of the first environmental condition detection device is determined by referencing the database; the first relative location of the environmental condition is centered on the location of the first environmental condition detection device; and the first intensity value is graphically represented by a radius, a color, or a combination thereof.

An aspect as in one of the preceding two paragraphs provides a system, the central computer to: receive a second alert from the first environmental condition detection device, wherein the second alert indicates a second magnitude of the environmental condition characteristic detected by the sensor; determine a second intensity value for the environmental condition based at least in part on the second magnitude of the environmental condition characteristic indicated by the second alert; and revise the heatmap to graphically represent the second intensity value for the environmental condition.

An aspect as in one of the preceding three paragraphs provides a system, the central computer to: receive a second alert from a second environmental condition detection device of the plurality of environmental condition detection devices based on the detection of an environmental condition characteristic in proximity to the second environmental condition detection device, wherein the second alert indicates a second magnitude of the environmental condition characteristic detected by the sensor of the second environmental condition detection device; determine a location of the second environmental condition detection device based at least in part on the second alert; determine a second relative location of the environmental condition based at least in part on the location of the second environmental condition detection device; determine a second intensity value for the environmental condition based at least in part on the magnitude of the environmental condition characteristic indicated by the second alert; and revise the heatmap to graphically represent the second relative location and second intensity value of the environmental condition.

An aspect as in one of the preceding four paragraphs provides a system, wherein: to determine the second relative location of the environmental condition comprises to determine an intermediate location relative to the locations of the first and second environmental condition detection devices, the intermediate location to represent a more likely location of the environmental condition than the locations of the first and second environmental condition detection devices; and to revise the heatmap to graphically represent the second relative location comprises graphically representing the intermediate location.

An aspect as in one of the preceding five paragraphs provides a system, the central computer to: determine a direction of spread for the environmental condition based at least in part on the relative locations of the first and second environmental condition detection devices; determine a rate of spread for the environmental condition based at least in part on a difference in time between receiving the first and second alerts; and revise the heatmap to graphically represent the direction and rate of spread for the environmental condition.

According to an aspect, there is provided an article of manufacture, comprising a non-transitory machine-readable medium, the medium including instructions that, when loaded and executed by a processor, cause the processor to: receive a first alert from a first environmental condition detection device based on the detection of an environmental condition characteristic in proximity to the first environmental condition detection device, wherein: the first environmental condition detection device comprises a sensor to detect a magnitude of the environmental condition characteristic; the first alert indicates a first magnitude of the environmental condition characteristic detected by the sensor; determine a location of the first environmental condition detection device; determine a first relative location of the environmental condition based on the location of the first environmental condition detection device; determine a first intensity value for the environmental condition based at least in part on the magnitude of the environmental condition characteristic indicated by the first alert; and generate a heatmap to graphically represent the first relative location and first intensity value of the environmental condition.

An aspect as in the preceding paragraphs provides an article of manufacture, wherein the instructions cause the processor to: receive a second alert from the first environmental condition detection device, wherein the second alert indicates a second magnitude of the environmental condition characteristic detected by the sensor; determine a second intensity value for the environmental condition based at least in part on the second magnitude of the environmental condition characteristic indicated by the second alert; and revise the heatmap to graphically represent the second intensity value for the environmental condition.

An aspect as in one of the preceding two paragraphs provides an article of manufacture, wherein the instructions cause the processor to: receive a second alert from a second environmental condition detection device based on the detection of an environmental condition characteristic in proximity to the second environmental condition detection device, wherein: the second environmental condition detection device comprises a sensor to detect a magnitude of the environmental condition characteristic; the second alert indicates a second magnitude of the environmental condition characteristic detected by the sensor; determine a location of the second environmental condition detection device based at least in part on the second alert; determine a second relative location of the environmental condition based at least in part on the location of the second environmental condition detection device; determine a second intensity value for the environmental condition based at least in part on the magnitude of the environmental condition characteristic indicated by the second alert; and revise the heatmap to graphically represent the second relative location and second intensity value of the environmental condition.

An aspect as in one of the preceding three paragraphs provides an article of manufacture, wherein: to determine the second relative location of the environmental condition comprises to determine an intermediate location relative to the locations of the first and second environmental condition detection devices, the intermediate location to represent a more likely location of the environmental condition than the locations of the first and second environmental condition detection devices; and to revise the heatmap to graphically represent the second relative location comprises graphically representing the intermediate location.

An aspect as in one of the preceding four paragraphs provides an article of manufacture, wherein the instructions cause the processor to: determine a direction of spread for the environmental condition based at least in part on the relative locations of the first and second environmental condition detection devices; determine a rate of spread for the environmental condition based at least in part on a difference in time between receiving the first and second alerts; and revise the heatmap to graphically represent the direction and rate of spread for the environmental condition.

### BRIEF DESCRIPTION OF THE FIGURES

FIG. 1 illustrates a side view of an environmental condition detection device including a light source and sensor to emit and detect light.

FIGS. 2A and 2B illustrate side and top views of an environmental condition detection device, respectively, including a light source and sensor to emit and detect light.

FIG. 3 illustrates a top view of an environmental condition detection device including a light source and sensor to emit and detect light.

FIG. 4 illustrates a block diagram of an environmental condition detection device including a light source and sensor to emit and detect light.

FIG. 5 shows a block diagram of environmental condition detection system.

FIG. 6 provides a flowchart of a method for generating a heatmap, which may be implemented on environmental condition detection system.

FIG. 7A provides a schematic representation of a building structure floorplan.

FIG. 7B shows a heatmap generated relative to the schematic representation of a building structure floorplan of FIG. 7A.

FIG. 7C shows a heatmap generated relative to the schematic representation of a building structure floorplan of FIG. 7A three seconds later than the heatmap of FIG. 7B.

FIG. 7D shows a heatmap generated relative to the schematic representation of a building structure floorplan of FIG. 7A five seconds later than the heatmap of FIG. 7B.

FIG. 7E shows a heatmap generated relative to the schematic representation of a building structure floorplan of FIG. 7A thirty seconds later than the heatmap of FIG. 7B.

The reference number for any illustrated element that appears in multiple different figures generally has the same meaning across the multiple figures, and the mention or discussion herein of any illustrated element in the context of any particular figure generally applies to each other figure, if any, in which that same illustrated element is shown.

### DETAILED DESCRIPTION

By knowing the physical location of each detector in the building, a heatmap of environmental conditions detected by the environmental condition detection device sensors can be created. In some examples, a heatmap may be a graphical representation of data where values are depicted visually, e.g., using color coding, gradients, topographical type lines, and combinations thereof, without limitation. In some examples, a heatmap may include a visual depiction of a building indicating the locations of various environmental condition detection device and with portions indicating the locations of any detected environmental conditions. Some heatmaps may also depict the intensity of environmental conditions, e.g., through use of different colors, gradients, line spacing, circles with different radii, and combinations thereof, without limitation. The term heatmap is not limited to any specific type of environmental condition or method of graphically representing the location and intensity of such environmental conditions. Using aggregate data from multiple environmental condition detection devices in a networked system of environmental condition detection devices could allow for the localization and monitoring of a detected environmental condition. For example, a heatmap comprised of such data may show where a source of the fire is located, which directions it is spreading, and how fast it is spreading. As another example, a heatmap comprised of such data may show the relative source of a toxic gas leak, to where it is spreading, and how fast it is spreading. In some examples, safe exit routes may be determined and communicated to occupants of a building so the occupants can avoid the environmental condition. By localizing and monitoring the environmental condition, authorities such as building maintenance or emergency services can more quickly respond to and correct the issue. This could potentially improve the safety of the occupants, reduce building overhead costs by more easily locating maintenance issues, and enabling advanced analytics on building usage for interested stakeholders.

Some environmental condition detection devices may have the ability to report the concentration of an environmental condition in addition to the detection of such. Having access to the concentration, such as in the case of carbon monoxide, could allow for more accurate and fine-tuned heat mapping across the building. Tracking of temperature gradients across devices could allow for the notification of issues such as doors and windows being left open, and rough occupancy estimates, all using the data from the networked environmental condition detection devices. By using a heat map of devices, the actual location of the source can be more quickly and easily identified. This is especially useful in buildings with many visual obstructions because of walls, equipment, inventory, occupants, without limitation.

In one aspect, a heat map may be based on whether an alert is issued when an environmental condition characteristic has been observed to exceed a preselected threshold. According to other aspects, a heat map may be continuously updated, regardless of an alert, wherein the heat map may be based on real-time data corresponding to the magnitude, amount, quality, or degree of an environmental condition characteristic. In further aspects, both alerts and real-time data corresponding to the magnitude, amount, quality, or degree may be used to generate a heat map. In an aspect, when an alert is generated by an environmental condition detection device, real-time data corresponding to the magnitude, amount, quality, or degree may be taken from additional environmental condition detection devices in the system, so that many devices contribute data to generate a heat map as soon as a first device detects an environmental condition characteristic above a threshold. The heat map may plot based on all detectors all the time and “below alert” data may be watched and investigated if repeated as a predictor of trouble or just bad behavior.

An environmental condition detection device may measure a temperature or humidity, or a temperature or humidity gradient could be measured across multiple environmental condition detection devices to locate abnormalities. An environmental condition detection device may determine personnel occupancy detection based on CO₂ measurements. An environmental condition detection device may detect any type of environmental condition characteristic, including without limitation, hazardous conditions and non-hazardous conditions. An environmental condition detection device may be a life safety device, such as for example, a smoke detector. An environmental condition characteristic may be, for example without limitation, smoke particles, a gas density (e.g., oxygen, carbon dioxide, carbon monoxide, without limitation), temperature, humidity, light, sound, pressure, heat, odor, a toxic gas, or a combination thereof.

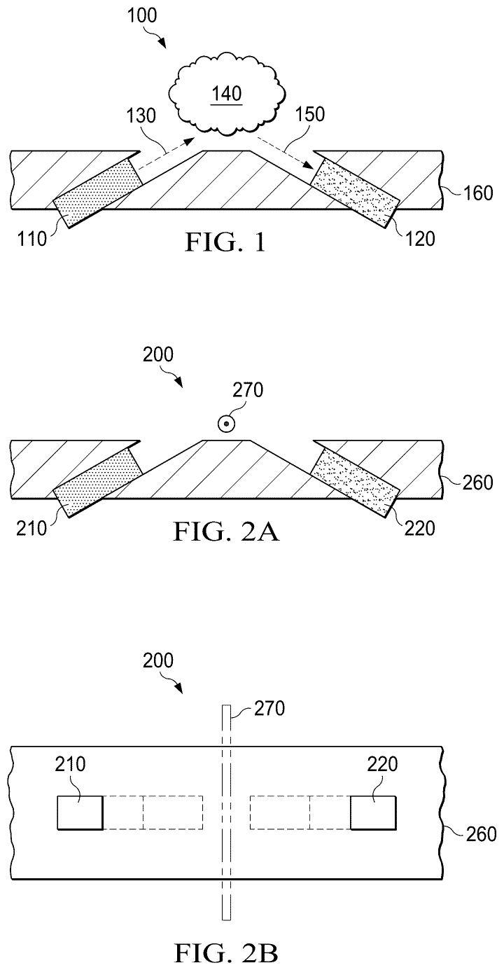

FIG. 1 illustrates a side view of an environmental condition detection device including a light source and sensor to emit and detect light. Environmental condition detection device 100 may include light source 110 and light sensor 120.

Light source 110 may emit light beam 130. Light source 110 may be any suitable type of light source, such as, but not limited to, a light emitting diode (LED), a vertical cavity surface emitting laser, or an incandescent light bulb. Light beam 130 may be formed of infrared, visible, or ultraviolet light. When smoke is present, light beam 130 may reflect off smoke particles 140, resulting in reflected light beam 150. Reflected light beam 150 may be received by light sensor 120. Light sensor 120 may be any suitable type of light sensor, such as, but not limited to, a photodiode or a phototransistor. In some examples, light sensor 120 may include multiple light sensors. When reflected light beam 150 is received by light sensor 120, light sensor 120 may generate an electrical signal that may be analyzed to determine when to sound a fire alarm or to determine smoke density or concentration.

Light source 110 and light sensor 120 may be mounted in carrier 160. Carrier 160 may provide connections between light source 110, light sensor 120, and other circuits in photoelectric smoke detector 100, such as, but not limited to, a control circuit, alarm circuit, and power supply. Light source 110 and light sensor 120 may be spaced apart from each other such that light sensor 120 does not receive light beam 130 directly.

FIGS. 2A and 2B illustrate side and top views of an environmental condition detection device, respectively including a light source and sensor to emit and detect light. Light source 210, light sensor 220, and carrier 260 may be similar to light source 110, light sensor 120, and carrier 160, respectively, shown in FIG. 1. When light source 210 emits a light beam, such as light beam 130, the reflected light beam, such as reflected light beam 150, is reflected about axis of reflection 270.

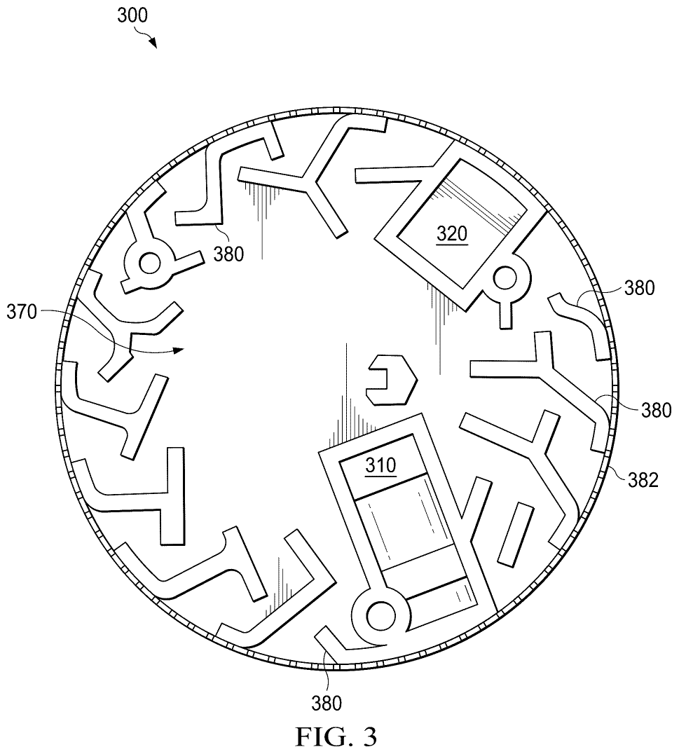

FIG. 3 illustrates a top view of an environmental condition detection device including a light source and sensor to emit and detect light, according to examples of the present disclosure. Environmental condition detection device 300 may include light source 310 and light sensor 320 housed in condition detection chamber 370 defined at the periphery by a screen 382 and surrounded by baffles 380 within the screen 382.

Light source 310 may be similar to light source 110 shown in FIG. 1 and light sensor 320 may be similar to light sensor 120 shown in FIG. 1. Light source 310 and light sensor 320 may be used to detect the presence of smoke particles within condition detection chamber 370.

Baffles 380 may be arranged along the outer perimeter of condition detection chamber 370. Baffles 380 may allow smoke to enter condition detection chamber 370 and may reduce the amount of extraneous light entering condition detection chamber 370. If extraneous light enters the chamber, the extraneous light may be detected by light sensor 320, causing the smoke detector to incorrectly identify the presence of smoke particles. Extraneous light entering condition detection chamber 370 (referred to as “baffle reflection leakage light”) may be light reflected off baffles 380.

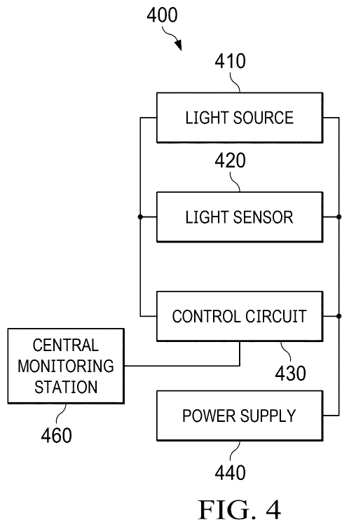

FIG. 4 illustrates a block diagram of an environmental condition detection device including a light source and sensor to emit and detect light, according to examples of the present disclosure. Environmental condition detection device 100 may include light source 410, light sensor 420, control circuit 430, and power supply 440.

Light source 410 may be similar to light source 110, light source 210, or light source 310 described with respect to FIGS. 1, 2, and 3, respectively. Light source 410 may emit a light beam based on a command from control circuit 430. Light source 410 may be any suitable type of light source, such as, but not limited to, a light emitting diode (LED), a vertical cavity surface emitting laser, or an incandescent light bulb.

Light sensor 420 may be similar to light sensor 120, light sensor 220, or light sensor 320 described with respect to FIGS. 1, 2, and 3, respectively. Light sensor 420 may be any suitable type of light sensor, such as, but not limited to, a photodiode or a phototransistor. In some examples, light sensor 420 may include multiple light sensors. When a reflected light beam is received by light sensor 420, light sensor 420 may generate an electrical signal that may be transmitted to control circuit 430 for processing and analysis to determine when to sound a fire alarm.

Control circuit 430 may receive the electrical signal from light sensor 420 and process and analyze the signal. Control circuit 430 may, when the electrical signal from light sensor 420 exceeds a threshold, sound an alarm indicating the presence of smoke in the vicinity of environmental condition detection device 400. Control circuit 430 may include a central processing unit (CPU), a general purpose processor, a specific purpose processor, a microcontroller, a programmable logic controller (PLC), a digital signal processor (DSP), an analog front-end (AFE), an application specific integrated circuit (ASIC), a field-programmable gate array (FPGA) or other programmable logic device, discrete gate or transistor logic, discrete hardware components, other programmable device, or any combination thereof.

Power supply 440 may power the components of environmental condition detection device 400 including light source 410, light sensor 420, and control circuit 430. Control circuit 140 may be communicatively coupled to a central monitoring station 160.

Control circuit 140 may receive signals from light sensor 120 corresponding to the amount of reflected light.

Environmental condition detection device 100 may rely on the reflected light beam 130 being reflected off smoke particles 140 to detect a smoke condition, e.g., a smoke condition caused by fire. As smoke particles 140 enter condition detection chamber 370, smoke particles 140 may reflect portions of light beam 130, illustrated as reflected light beam 150. Light sensor 120 may detect reflected light beam 150. Control circuit 430 may receive signals from light sensor 120 corresponding to the intensity of reflected light beam 150. For example, light sensor 120 may be calibrated to output a range of current or voltage values based on the amount of light detected by light sensor 120. In some examples, a higher current or voltage value may indicate a greater amount or intensity of light. In an optical-scattering type smoke detector such as environmental condition detection device 100, higher current or voltage values may indicate more light is being received by light sensor 120, which may indicate the presence of smoke particles 140 scattering or reflecting part or all of light beam 130 toward light sensor 120. By calibrating the voltage to the magnitude or degree of light detected, control circuit 430 may estimate a percentage of light reflection. In some examples, the magnitude or degree of light reflection may be directly proportional to the amount of light detected by light sensor 120 compared to a baseline established when condition detection chamber 370 is clear of obstructions that may scatter or reflect portions of light beam 130 toward light sensor 120. The voltage range for light sensor 120 may be calibrated to be near zero volts (or another low level current or voltage value) when no reflected light is detected (e.g., indicating 0% reflection) for the baseline condition to a high level current value or a high level voltage value (e.g., 1V, 3V, or 5V, depending on the type of light sensor) for a high level scattering condition (e.g., indicating 100% reflection). A higher percentage of light reflection (e.g., indicated by a higher voltage compared to the baseline) may indicate a higher concentration of smoke particles 140 within condition detection chamber 370.

Control circuit 430 may compare the voltage received from light sensor 120 to a threshold value (e.g., a voltage threshold that indicates an amount of scattering or reflection indicative of an environmental condition) to determine the presence of an environmental condition. For example, if a current or voltage value from light sensor 120 corresponding to at least 10% reflection, without limitation, is received by control circuit 430, environmental condition detection device 100 may trigger an alarm, an alert, or send a signal corresponding to a magnitude, amount, or degree of light sensed. An alarm may include, e.g., an audible alarm. An alert may be, e.g., a signal or message communicated to central monitoring station 460. An alert or signal may include a device identifier to identify the device sending the alert. An alert or signal may also include a timestamp. An alert or signal may also include data corresponding to the magnitude or amount of light detected by light sensor 120.

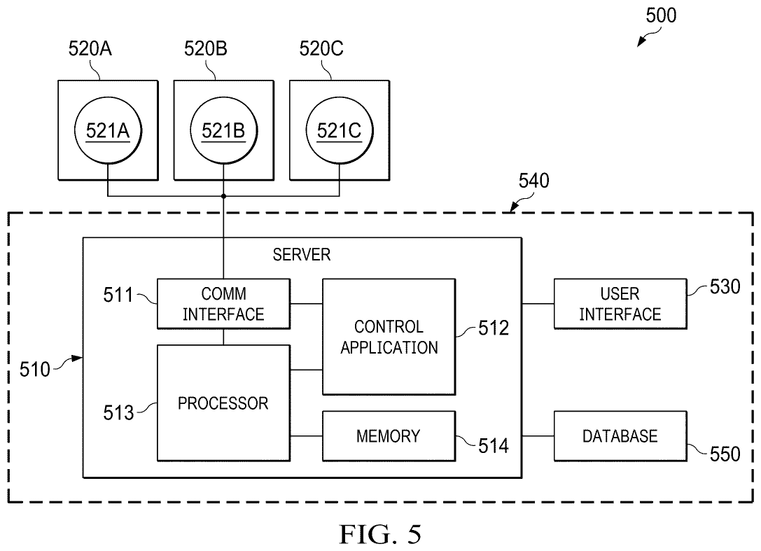

FIG. 5 shows a block diagram of environmental condition detection system 500. Environmental condition detection system 500 may include server 510. Server 510 may include processor 513 and memory 514. Processor 513 may be electrically coupled to memory 514. Processor 513 may transmit/retrieve data to/from memory 514. Server 510 may include communication interface 511. Server 510 may include control application 512. In some examples, control application 512 may perform steps to localize and monitor signals from detectors indicating environmental conditions. In some examples, control application 512 may be implemented by a processor, e.g., processor 513. Sever 510 may be communicatively coupled to user interface 530. User interface 530 may include a display for displaying heatmaps in accordance with examples of the present disclosure. User interface 530 may be a touchscreen display for receiving inputs from a user. User interface 530 may also include peripherals for receiving inputs from a user, e.g., a keyboard and mouse, without limitation. Environmental condition detection system 500 may include multiple environmental condition detection devices, e.g., environmental condition detection devices 521A, 521B, and 521C. In some examples, environmental condition detection system 500 may include more or fewer environmental condition detection devices. Environmental condition detection devices 521A, 521B, and 521C may be located in different physical locations, e.g., locations 520A, 520B, and 520C, respectively. In some examples, locations 520A, 520B, and 520C may be different rooms in a building. In some examples, locations 520A, 520B, and 520C may be different locations in a commercial or industrial complex. Server 510 and user interface 530 may be located together or separately. In some examples, server 510 and user interface 530 may be in a central monitoring station 560. Environmental condition detection system 500 may include database 550. Database 550 may be located in central monitoring station 560. In some examples, database 550 may be located remotely from server 510 or central monitoring station 560. In some examples, database 550 may be in a datacenter and may be accessed via a network such as the Internet. Database 550 may store data regarding the identification, location, and calibration of environmental condition detection devices 521A, 521B, and 521C. In some examples, the system may include one hundred or more environmental condition detection devices. Each environmental condition detection device may be installed and connected to the system in the same manner as environmental condition detection devices 521A, 521B, and 521C. Information regarding individual environmental condition detection devices in the system may be stored in database 550.

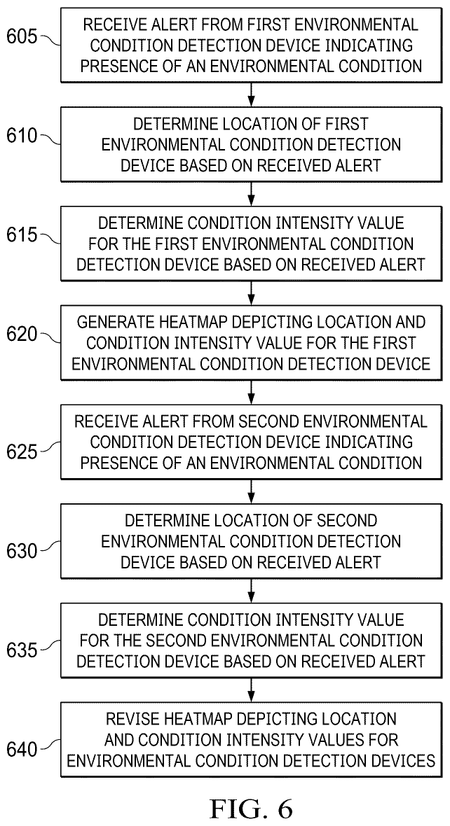

FIG. 6 provides a flowchart of a method 600 for generating a heatmap. Method 600 may be implemented on environmental condition detection system 500. In some examples, method 600 may be implemented by a server, e.g., server 510 of environmental condition detection system 500. In some examples, method 600 may be implemented by a control application, e.g., control application 512 of environmental condition detection system 500. An alert is received 605 from a first environmental condition detection device indicating the presence of an environmental condition. In some examples, the alert may be received by a server from a smoke detector indicating the presence of a fire. A location of first environmental condition detection device is determined 610 based on the received alert. In some examples, the alert may contain an identification code for the environmental condition detection device that sent the alert. The location may be determined by referencing a database that contains identification and location information for the environmental condition detection devices in an environmental condition detection system. In some examples, the database may be populated by technicians as environmental condition detection devices are installed in different locations. According to one aspect, individual environmental condition detection devices may detect a magnitude, quality, amount, or degree of an environmental condition characteristic when the magnitude, quality, amount, or degree becomes detectable by a sensor, and the sensor has that ability to report the magnitude, quality, amount, or degree of the environmental condition characteristic between low and high values.

A condition intensity value is determined 615 for the first environmental condition detection device based on the received alert. In some examples, the alert may contain information indicating a relative intensity of the environmental condition. In some examples, the environmental condition detection device may include information regarding a value from a sensor in the environmental condition detection device that was used to detect the environmental condition.

In some examples, the environmental condition detection device may be a light-obscuration type photoelectric smoke detector (e.g., smoke detector 100) or an optical-scattering type photoelectric smoke detector (e.g., smoke detector 200). The smoke detector may provide information regarding the current or voltage value from a light sensor (e.g., light sensor 120). In some examples, the environmental condition detection device may process the signal from the light sensor and determine an amount of light reflection. The amount of light reflection may be represented as a percentage based on the calibration of the environmental condition detection device. In some examples, a server may use the amount of light reflection to determine a condition intensity value for the environmental condition detection device. A low amount of light reflection may indicate a low concentration of smoke and may result in a relatively low condition intensity value. A higher amount of light reflection may indicate a greater concentration of smoke and may result in a relatively higher condition intensity value.

In some examples, a server may interpret information received regarding a current or voltage value to determine the condition intensity value. In some examples, a control application may interpret the information regarding the current or voltage value to determine the condition intensity value. Interpreting the information regarding the current or voltage value may include correlating the current or voltage value to condition detection level based on calibration data for the environmental condition detection device. For example, if the server receives information regarding a current or voltage value from an environmental condition detection device, the server may lookup or interpolate an amount of light from entries in a database from the calibration of the environmental condition detection device. The server may determine a condition intensity value for the environmental condition detection device based on the amount of reflection.

Referring to FIG. 6, a heatmap is generated 620 depicting the location and a condition intensity value for the first environmental condition detection device. A control application may use installation information and the condition intensity value to graphically depict the location of the environmental condition detection device and the relative intensity of the condition. In some examples, the relative intensity of the condition may be indicated by color coding portions of the building layout around the location of the environmental condition detection device. In some examples, relative intensity may be indicated by a color gradient. In some examples, relative intensity may be indicated by the radius of a circle around the location of the environmental condition detection device. In some examples, the radius of a circle around the location of the environmental condition detection device may indicate a relative proximity to the condition. For example, if the information received from an environmental condition detection device indicates a high concentration of smoke, the radius may initially start as a smaller radius around that environmental condition detection device indicating the fire is close to the environmental condition detection device.

An alert is received 625 from a second environmental condition detection device indicating the presence of the environmental condition. For example, this may be an alert from a second smoke detector at a different location. A location of the second environmental condition detection device is determined 630 based on the received alert. A condition intensity value is determined 630 for the second environmental condition detection device based on the received alert. Elements 630 and 635 may be implemented similarly to 610 and 615, respectively.

The heatmap is revised 640 to depict the location and condition intensity values for the first and second environmental condition detection devices. For example, the heatmap may be revised to graphically depict the location of the second environmental condition detection device and a condition intensity relative to the first environmental condition detection device in the same manner used to depict that information for the first environmental condition detection device. The color coding, gradient, or radius of a circle around the first environmental condition detection device may be adjusted based on the additional information from the second environmental condition detection device. Elements 625-640 of method 600 may be repeated as alerts are received from subsequent environmental condition detection devices in an environmental condition detection system. The heatmap may be continuously revised based on new information received from the environmental condition detection devices during the course of an environmental condition.

According to one aspect, individual environmental condition detection devices may simply detect the presence of an environmental condition characteristic when the magnitude, quality, amount, or degree crosses a predetermined threshold. The control application may determine an assumed location of the source of the environmental condition by measuring the delays between detections at different environmental condition detection devices. For example, as soon as a first environmental condition detection device detects an environmental condition characteristic, the control application begins to measure time. Further, the control application generates a heatmap with a first circle around the first environmental condition detection device. When a second environmental condition detection device detects the environmental condition characteristic, the control application records the delay between the two detections. A database may contain delay times corresponding to how long it takes environmental condition characteristic material to travel relative to the environmental condition detection devices within a particular building or structure. The control application updates the heatmap with a second circle around the second environmental condition detection device, wherein the radius of the second circle is based on the delay. The control application may assume a location of the source of the environmental condition based on the delay between the two detections. If the delay is relatively short, the control application may assume the location of the source of the environmental condition is between the first and second environmental condition detection devices. If the delay is relatively long, the control application may assume the first environmental condition detection device is between the location of the source of the environmental condition and the second environmental condition detection device. When a third environmental condition detection device detects the environmental condition characteristic, the control application records the delays between the three detections. The control application updates the heatmap with a third circle around the third environmental condition detection device, wherein the radius of the third circle is based on one or more of the delays. The control application may assume a location of the source of the environmental condition based on a triangulation using the circles.

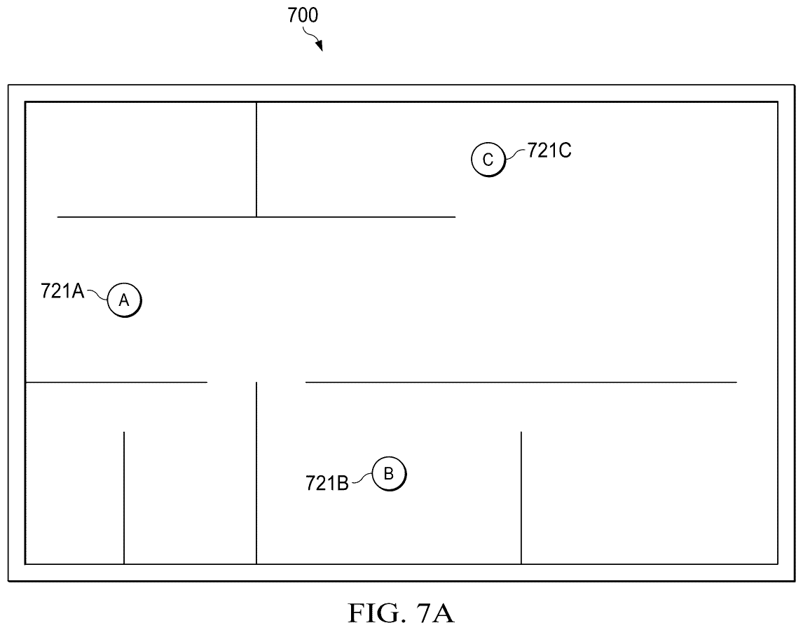

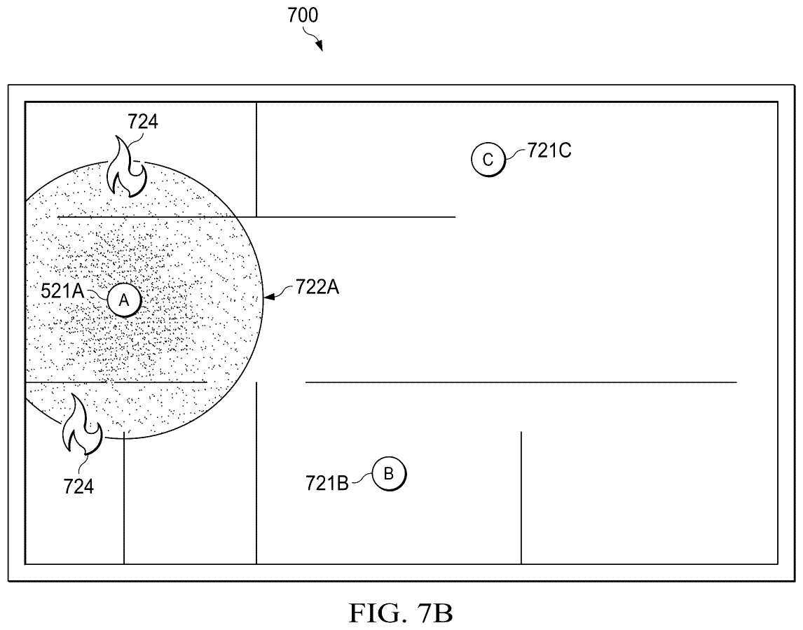

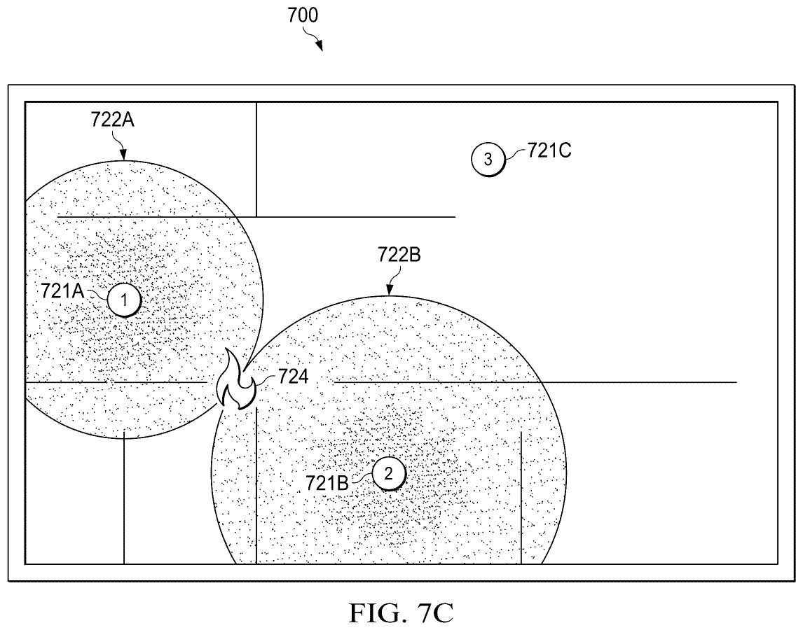

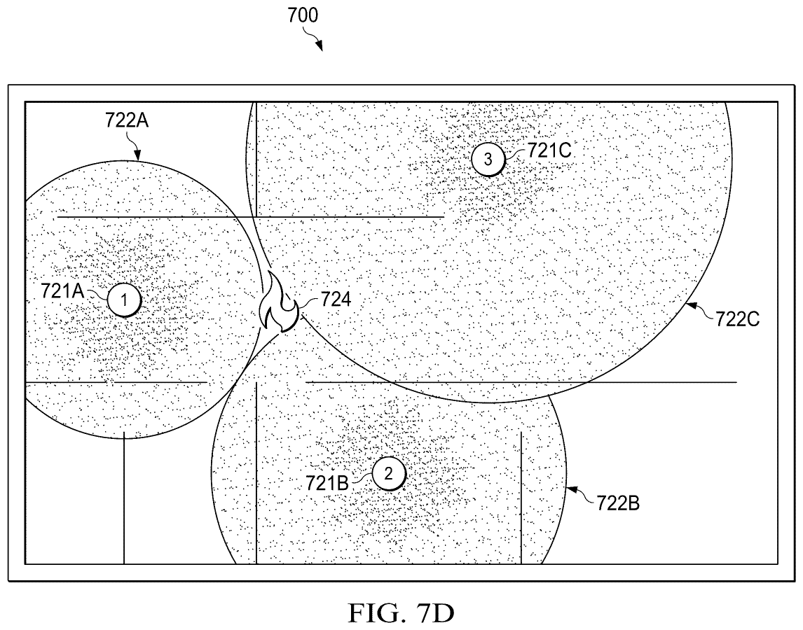

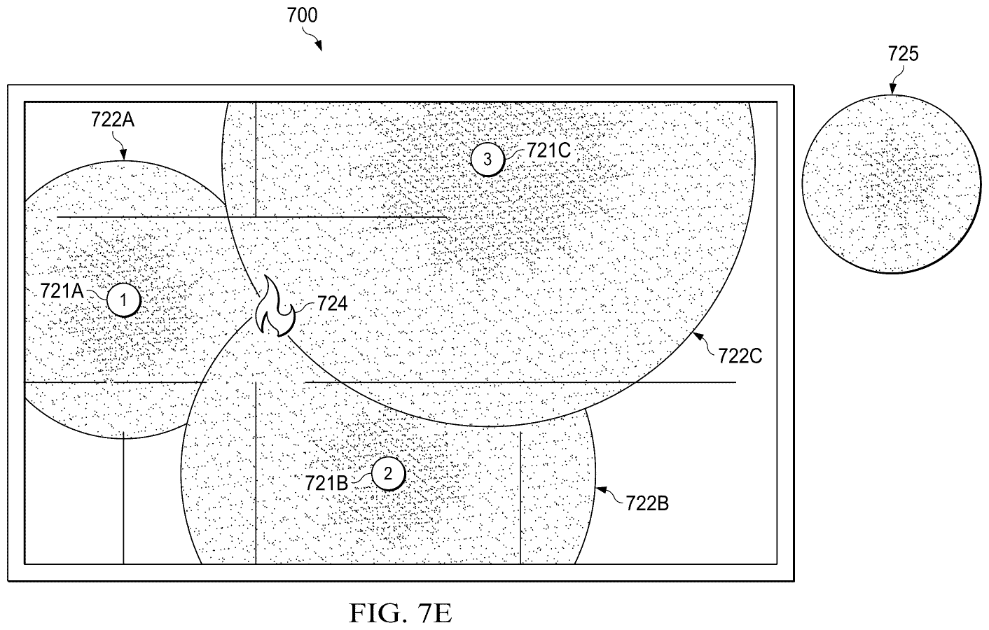

FIG. 7A provides a schematic representation of a building structure floorplan 500. Environmental condition detection devices 721A, 721B, and 721C are identified at locations A, B, and C. According to an example, environmental condition detection device 721A detects smoke at 30% reflected light. Environmental condition detection device 721B detects smoke at 25% reflected light three seconds later than the detection by environmental condition detection device 721A. Environmental condition detection device 721C detects smoke at 20% reflected light five seconds later than the detection by environmental condition detection device 721A.

FIG. 7B shows a heatmap generated relative to the schematic representation of a building structure floorplan 700 of FIG. 7A. Generally, a first device to detect has a relatively smaller heatmap circle radius because the source of the environmental condition is assumed to be relatively close to this device. Devices that detect a condition, such as smoke, after the first device have a larger circle radius, because the source of the environmental condition is assumed to be relatively farther away from this device. Higher reflected light level decreases the heatmap circle radius. In this example, the heatmap generates a circle 722A in response to environmental condition detection device 721A detecting an environmental condition, such as smoke, at 30% reflected light. The heatmap further assumes a source of the smoke, e.g., a fire 724, is located somewhere on the periphery of the circle 722A.

FIG. 7C shows a heatmap generated relative to the schematic representation of a building structure floorplan 700 of FIG. 7A three seconds later than the heatmap of FIG. 7B. In this example, environmental condition detection device 721B detects smoke at 25% reflected light three seconds later than the detection by environmental condition detection device 721A. The heatmap generates a circle 722B in response to environmental condition detection device 721B detecting smoke at 25% reflected light. Because the reflected light detected by environmental condition detection device 721B is less than the reflected light detected by environmental condition detection device 721A, the radius of the circle 722B is larger than the radius of the circle 722A. The heatmap further assumes a source of the smoke, e.g., a fire 724, is located somewhere on the peripheries of both circles 722A and 722B.

FIG. 7D shows a heatmap generated relative to the schematic representation of a building structure floorplan 700 of FIG. 7A five seconds later than the heatmap of FIG. 7B. In this example, environmental condition detection device 721C detects smoke at 20% reflected light five seconds later than the detection by environmental condition detection device 721A. The heatmap generates a circle 722C in response to environmental condition detection device 721C detecting smoke at 20% reflected light. Because the reflected light detected by environmental condition detection device 721C is less than the reflected light detected by environmental condition detection device 721A, the radius of the circle 722C is larger than the radius of the circle 722A. The heatmap further assumes a source of the smoke, e.g., a fire 724, is located somewhere on the peripheries of circles 722A, 722B, and 722C. Overlapping heatmap circles may identify a location of the source of the condition. If exact sensor positions and building dimensions are more precisely determined, locating source locations of conditions may be more precise.

FIG. 7E shows a heatmap generated relative to the schematic representation of a building structure floorplan 700 of FIG. 7A thirty seconds later than the heatmap of FIG. 7B. At this moment in time, environmental condition detection device 721A detects smoke at 25% reflected light, environmental condition detection device 721B detects smoke at 20% reflected, and environmental condition detection device 721C detects smoke at 15% reflected light. The heatmap generates circles 722A, 722B, and 722C slightly larger than previously illustrated because the reflected light detected by the environmental condition detection devices 721A, 721B, and 721C is respectively less than the reflected light detected previously. The heatmap now assumes the source of the smoke, e.g., a fire 724, is located somewhere where the circles 722A, 722B, and 722C overlap. FIG. 7E further shows an evacuation rendezvous location 725 for individuals to be instructed to go to upon evacuation of the building.

Although example examples have been described above, other variations and examples may be made from this disclosure without departing from the spirit and scope of these examples.

What is claimed is:

1. A method, comprising:
receiving a first alert from a first environmental condition detection device based on detection of an environmental condition characteristic in proximity to the first environmental condition detection device, wherein:
the first environmental condition detection device comprises a sensor to detect a magnitude of the environmental condition characteristic;
the first alert indicates a first magnitude of the environmental condition characteristic detected by the sensor;
determining a location of the first environmental condition detection device;
determining a first relative location of the environmental condition based on the location of the first environmental condition detection device;
determining a first intensity value for the environmental condition based at least in part on the magnitude of the environmental condition characteristic indicated by the first alert; and
generating a heatmap to graphically represent the first relative location and first intensity value of the environmental condition.

2. The method of claim 1, wherein:
the magnitude of the environmental condition characteristic is indicated by a value from the sensor, wherein the value corresponds to current or voltage;
the first alert comprises a timestamp and identification information for the first environmental condition detection device;
the location of the first environmental condition detection device is determined by referencing a database comprising identification and location information;
the first relative location of the environmental condition is centered on the location of the first environmental condition detection device; and
the first intensity value is graphically represented by a radius, a color, or a combination of radius and color.

3. The method of claim 1, comprising:
receiving a second alert from the first environmental condition detection device, wherein the second alert indicates a second magnitude of the environmental condition characteristic detected by the sensor;
determining a second intensity value for the environmental condition based at least in part on the second magnitude of the environmental condition characteristic indicated by the second alert; and
revising the heatmap to graphically represent the second intensity value for the environmental condition.

4. The method of claim 1, comprising:
receiving a second alert from a second environmental condition detection device based on the detection of a environmental condition characteristic in proximity to the second environmental condition detection device, wherein:
the second environmental condition detection device comprises a sensor to detect a magnitude of the environmental condition characteristic;
the second alert indicates a second magnitude of the environmental condition characteristic detected by the sensor;
determining a location of the second environmental condition detection device based at least in part on the second alert;
determining a second relative location of the environmental condition based at least in part on the location of the second environmental condition detection device;
determining a second intensity value for the environmental condition based at least in part on the magnitude of the environmental condition characteristic indicated by the second alert; and
revising the heatmap to graphically represent the second relative location and second intensity value of the environmental condition.

5. The method of claim 4, wherein:
determining the second relative location of the environmental condition comprises determining an intermediate location relative to locations of the first and second environmental condition detection devices, the intermediate location to represent a more likely location of the environmental condition than the locations of the first and second environmental condition detection devices; and
revising the heatmap to graphically represent the second relative location comprises graphically representing the intermediate location.

6. The method of claim 4, comprising:
determining a direction of spread for the environmental condition based at least in part on the relative locations of the first and second environmental condition detection devices;
determining a rate of spread for the environmental condition based at least in part on a difference in time between receiving the first and second alerts; and
revising the heatmap to graphically represent the direction and rate of spread for the environmental condition.

7. The method of claim 1, wherein the heatmap visually depicts a location and an intensity of the environmental condition using color, gradients, topographical lines, or a combination color, gradients, or topographical lines.

8. The method of claim 1, wherein the environmental condition characteristic comprises smoke particles, light, heat, odor, a toxic gas, or a combination thereof.

9. The method of claim 1, comprising:
determining an exit path for people to avoid the environmental condition based on the heatmap; and
revising the heatmap to indicate the safe exit path.

10. A system, comprising:
a plurality of environmental condition detection devices, wherein respective ones of the environmental condition detection devices comprise a sensor to detect a magnitude of a environmental condition characteristic;
a central computer connected to the plurality of environmental condition detection devices and a database, the central computer to:
receive a first alert from a first environmental condition detection device based on the detection of the environmental condition characteristic in proximity to the first environmental condition detection device, wherein the first alert indicates a magnitude of the environmental condition characteristic detected by the sensor of the first environmental condition detection device;
determine a location of the first environmental condition detection device;
determine a first relative location of the environmental condition based on the location of the first environmental condition detection device;
determine a first intensity value for the environmental condition based at least in part on the magnitude of the environmental condition characteristic indicated by the first alert; and
generating a heatmap to graphically represent the first relative location and first intensity value of the environmental condition.

11. The system of claim 10, comprising:
a database connected to the central computer, the database comprising information regarding an identity and location of respective ones of the environmental condition detection devices of the plurality of environmental condition detection devices;
wherein:
the magnitude of the environmental condition characteristic is indicated by a value from the sensor, wherein the value corresponds to current or voltage;
the first alert comprises a timestamp and identification information for the first environmental condition detection device;
the location of the first environmental condition detection device is determined by referencing the database;
the first relative location of the environmental condition is centered on the location of the first environmental condition detection device; and
the first intensity value is graphically represented by a radius, a color, or a combination thereof.

12. The system of claim 10, the central computer to:
receive a second alert from the first environmental condition detection device, wherein the second alert indicates a second magnitude of the environmental condition characteristic detected by the sensor;
determine a second intensity value for the environmental condition based at least in part on the second magnitude of the environmental condition characteristic indicated by the second alert; and
revise the heatmap to graphically represent the second intensity value for the environmental condition.

13. The system of claim 10, the central computer to:
receive a second alert from a second environmental condition detection device of the plurality of environmental condition detection devices based on detection of a environmental condition characteristic in proximity to the second environmental condition detection device, wherein the second alert indicates a second magnitude of the environmental condition characteristic detected by the sensor of the second environmental condition detection device;
determine a location of the second environmental condition detection device based at least in part on the second alert;
determine a second relative location of the environmental condition based at least in part on the location of the second environmental condition detection device;
determine a second intensity value for the environmental condition based at least in part on the magnitude of the environmental condition characteristic indicated by the second alert; and
revise the heatmap to graphically represent the second relative location and second intensity value of the environmental condition.

14. The system of claim 13, wherein:
to determine the second relative location of the environmental condition comprises to determine an intermediate location relative to locations of the first and second environmental condition detection devices, the intermediate location to represent a more likely location of the environmental condition than the locations of the first and second environmental condition detection devices; and
to revise the heatmap to graphically represent the second relative location comprises graphically representing the intermediate location.

15. The system of claim 13, the central computer to:
determine a direction of spread for the environmental condition based at least in part on the relative locations of the first and second environmental condition detection devices;
determine a rate of spread for the environmental condition based at least in part on a difference in time between receiving the first and second alerts; and
revise the heatmap to graphically represent the direction and rate of spread for the environmental condition.

16. An article of manufacture, comprising a non-transitory machine-readable medium, the medium including instructions that, when loaded and executed by a processor, cause the processor to:
receive a first alert from a first environmental condition detection device based on the detection of a environmental condition characteristic in proximity to the first environmental condition detection device, wherein:
the first environmental condition detection device comprises a sensor to detect a magnitude of the environmental condition characteristic;
the first alert indicates a first magnitude of the environmental condition characteristic detected by the sensor;
determine a location of the first environmental condition detection device;
determine a first relative location of the environmental condition based on the location of the first environmental condition detection device;
determine a first intensity value for the environmental condition based at least in part on the magnitude of the environmental condition characteristic indicated by the first alert; and
generate a heatmap to graphically represent the first relative location and first intensity value of the environmental condition.

17. The article of manufacture of claim 16, wherein the instructions cause the processor to:
receive a second alert from the first environmental condition detection device, wherein the second alert indicates a second magnitude of the environmental condition characteristic detected by the sensor;
determine a second intensity value for the environmental condition based at least in part on the second magnitude of the environmental condition characteristic indicated by the second alert; and
revise the heatmap to graphically represent the second intensity value for the environmental condition.

18. The article of manufacture of claim 16, wherein the instructions cause the processor to:
receive a second alert from a second environmental condition detection device based on detection of a environmental condition characteristic in proximity to the second environmental condition detection device, wherein:
the second environmental condition detection device comprises a sensor to detect a magnitude of the environmental condition characteristic;
the second alert indicates a second magnitude of the environmental condition characteristic detected by the sensor;
determine a location of the second environmental condition detection device based at least in part on the second alert;
determine a second relative location of the environmental condition based at least in part on the location of the second environmental condition detection device;
determine a second intensity value for the environmental condition based at least in part on the magnitude of the environmental condition characteristic indicated by the second alert; and
revise the heatmap to graphically represent the second relative location and second intensity value of the environmental condition.

19. The article of manufacture of claim 18, wherein:
to determine the second relative location of the environmental condition comprises to determine an intermediate location relative to locations of the first and second environmental condition detection devices, the intermediate location to represent a more likely location of the environmental condition than the locations of the first and second environmental condition detection devices; and
to revise the heatmap to graphically represent the second relative location comprises graphically representing the intermediate location.

20. The article of manufacture of claim 18, wherein the instructions cause the processor to:
determine a direction of spread for the environmental condition based at least in part on the relative locations of the first and second environmental condition detection devices;
determine a rate of spread for the environmental condition based at least in part on a difference in time between receiving the first and second alerts; and
revise the heatmap to graphically represent the direction and rate of spread for the environmental condition.
